(19) United States
(12) Patent Application Publication
(10) Pub. No.: US 2008/0144713 A1
(43) Pub. Date: Jun. 19, 2008

(54) ACM AWARE ENCODING SYSTEMS AND METHODS

(75) Inventors: Kevin D. Kimmich, Chardon, OH (US); Fan Mo, Stow, OH (US); Mark Vanderaar, Medina, OH (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 11/956,200

(22) Filed: Dec. 13, 2007

Related U.S. Application Data
(60) Provisional application No. 60/869,809, filed on Dec. 13, 2006.

(51) Int. Cl. H04N 7/26

(52) U.S. Cl. 375/240.02; 375/E07.126

(57) ABSTRACT

Methods, systems, and devices are described for hierarchical communication of a set of source data over a communication link. Sets of representation data may be generated by applying precoding schemes to a set of source data. The sets of representation data may be associated with coding and modulation schemes of varying order. Based on certain link conditions, the sets of representation data may be adaptively coded and modulated, using their associated coding and modulation schemes, for transmission over a communication link.

### CROSS REFERENCE

This application claims priority from co-pending U.S. Provisional Patent Application No. 60/869,809, filed on Dec. 13, 2006, entitled “ADAPTIVE CODING & MODULATION (ACM) AWARE ENCODER SYSTEM”. This Application hereby incorporates by reference the content of the aforementioned Application in its entirety, and for all purposes.

### BACKGROUND

The present invention relates to data communications in general and, in particular, to adaptive coding and modulation.

Service providers may desire to use communication systems to provide high availability to high-quality services for their subscribers. At times, however, changing link conditions (e.g., changes in weather) may result in changing availability of services to subscribers. Techniques like adaptive coding and modulation (ACM) may dynamically adjust coding and modulation schemes to adapt to these changing link conditions. For example, as link conditions change, the availability of services may be increased or maintained by using more reliable (lower order) coding and modulation schemes.

Lower order modulation and coding schemes may use more bandwidth to send error correction data, making them less bandwidth efficient. Because communication systems have limited bandwidth, decreasing bandwidth efficiency may decrease the amount of service-related information that may be transmitted per unit time. This trade-off may mean that service providers will have to choose between providing services with high availability or with high quality. Thus, there may be a need in the art for new ways to dynamically adjust transmission parameters to improve both the availability and the quality of services provided in changing link conditions.

### SUMMARY

Methods, systems, and devices are described for associating adaptive coding and modulation schemes with hierarchical precoding schemes to match changing link conditions in a communication network.

In some embodiments, source data (e.g., a video stream) is precoded into a set of hierarchical layers, which allow for different levels of playback (e.g., lower layers allowing lower resolution playback of the video, and higher layers allowing higher resolution playback of the video). Each layer may be associated with a coding and modulation scheme, such that different layers may be coded and/or modulated differently (e.g., for more or less reliable transmission). In certain embodiments, link conditions may be monitored for changes. As link conditions change, the associations between the layers and the coding and modulation schemes may dynamically adapt to those changes.

In one set of embodiments, a system for hierarchical representation of a set of source data in a satellite environment using adaptive coding and modulation is provided. The system may include a gateway, and the gateway may include a receiver unit, a precoder unit, an adaptive coding and modulation (ACM) unit, and a transceiver unit. The receiver unit may be configured to receive a set of source data. The precoder unit may be communicatively coupled with the receiver unit. The precoder may be configured to precode at least a subset of the set of source data using a first precoding scheme to generate a first set of representation data, wherein the first set of representation data is formatted to be decoded independently to provide a set of first-level playback data representing the set of source data. The precoder may be further configured to precode at least a subset of the set of source data using a second precoding scheme to generate a second set of representation data, wherein the second set of representation data is formatted to be decoded to provide a set of second-level playback data representing the set of source data when combined with the first representation. The ACM unit may be communicatively coupled with the precoder unit and configured to associate the first set of representation data with a first coding and modulation scheme, and associate the second set of representation data with a second coding and modulation scheme. The second coding and modulation scheme may be of a higher order than the first coding and modulation scheme. The transceiver unit may be communicatively coupled with the gateway and configured to transmit a first signal relating to the first set of representation data over a communication link using the first coding and modulation scheme, and to transmit a second signal relating to the second set of representation data over the communication link using the second coding and modulation scheme.

In some embodiments, the system may further include a subscriber terminal, configured to receive the first signal and the second signal from the communication link. In a first mode, the subscriber terminal may decode the first set of representation data to generate the set of first-level playback data representing the set of source data. In a second mode, the subscriber terminal may decode a combination of the first set of representation data and the second set of representation data to generate the set of second-level playback data representing the set of source data.

In other embodiments, the system may further include a profiler unit, communicatively coupled with the ACM unit. The profiler unit may be configured to determine a profile relating at least in part to a set of conditions for the communication link, a gateway, or a subscriber terminal. In certain embodiments, the ACM unit may be further configured to associate the sets of representation data with the coding and modulation schemes based at least in part on the profile.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 provides a simplified block diagram of a satellite communication system for use with various embodiments of the invention.

FIG. 2 provides a simplified block diagram of a device configured according to various embodiments of the invention.

FIG. 3 provides a simplified block diagram of a subscriber terminal according to various embodiments of the invention.

FIG. 4A provides a functional block diagram incorporating a precoder unit according to various embodiments of the invention.

FIG. 4B provides another functional block diagram incorporating a precoder unit according to various embodiments of the invention.

FIG. 4C provides yet another functional block diagram incorporating a precoder unit according to various embodiments of the invention.

FIG. 4D provides still another functional block diagram incorporating a precoder unit according to various embodiments of the invention.

FIG. 5 provides an illustration of an exemplary identifier table for use with various embodiments of the invention.

FIG. 6 provides a simplified block diagram of a controller unit according to various embodiments of the invention.

FIG. 7A provides a functional block diagram incorporating a processor unit according to various embodiments of the invention.

FIG. 7B provides another functional block diagram incorporating a processor unit according to various embodiments of the invention.

FIGS. 8A and 8B provide an exemplary embodiment illustrating adapting certain coding and modulation schemes to link conditions according to various embodiments of the invention.

FIG. 9 provides a flow diagram describing methods of transmitting hierarchical data in a layered communication system according to various embodiments of the invention.

FIG. 10 provides a flow diagram describing methods of receiving hierarchical data in a layered communication system according to various embodiments of the invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments, the methods may be performed in an order different than that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

Further, it will be appreciated that other and different components may be incorporated into or used by the devices and systems described herein, and functions of the various devices, systems, and components may be implemented in a number of ways. For example, the functions various components may be implemented in hardware, software, or firmware. Implementations of these functions may include one or more Application Specific Integrated Circuits (ASICs) adapted to perform a subset of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. Each may also be implemented, in whole or in part, with instructions embodied in a computer-readable medium, formatted to be executed by one or more general or application specific processors. Thus, the devices and systems may include different types and configurations of memory, which may be integrated into the hardware or may be one or more separate components.

The description provides methods, systems, and devices for associating adaptive coding and modulation schemes with hierarchical precoding schemes to match changing link conditions in a communication network. In some embodiments, the communication network is a satellite communication network in which a gateway transmits information to a plurality of subscriber terminals over a communication link.

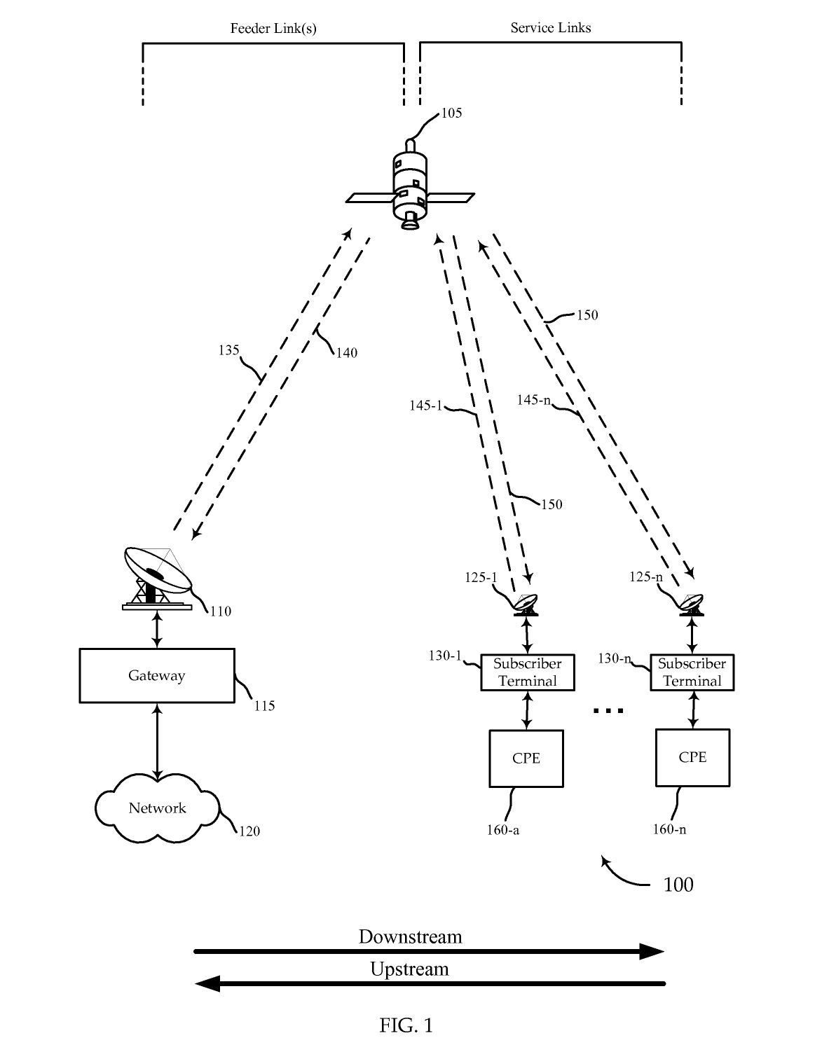

Turning first to FIG. 1, a simplified block diagram of a satellite communication system for use with various embodiments of the invention is provided. While a satellite communication system is used to illustrate various aspects of the invention, it is worth noting that certain principles set forth herein are applicable to a variety of other wireless systems, as well. The satellite communications system 100 includes a network 120, such as the Internet, interfaced with a gateway 115 that is configured to communicate with one or more subscriber terminals 130, via a satellite 105.

The network 120 may be any type of network and can include, for example, the Internet, an IP network, an intranet, a local- or wide-area network, a virtual private network, the Public Switched Telephone Network (“PSTN”), or any other type of network supporting data communication between devices described herein, in different embodiments. A network 120 may include both wired and wireless connections, including optical links. The network 120 may also transmit information about link conditions for one or more subscriber terminals 130 to the gateway 115. The network 120 may connect the gateway 115 with other gateways (not pictured), which are also in communication with the satellite 105, and which may share information on link conditions and other network metrics.

The gateway 115 provides an interface between the network 120 and the subscriber terminal 130. The gateway 115 may be configured to receive data and information directed to one or more subscriber terminals 130, and can format the data and information for delivery to the respective destination terminal 130 via the satellite 105. Similarly, the gateway 115 may be configured to receive upstream signals from the satellite 105 (e.g., from one or more subscriber terminals 130) directed to a destination in the network 120, and can format the received signals for transmission along the network 120.

For example, the gateway 115 may use adaptive coding and modulation (ACM) to generate a layered transmission of the information. ACM may allow the satellite communication system 100 to dynamically adjust the coding and modulation schemes applied to transmissions to adapt to changing link conditions. Lower order coding and modulation schemes may use lower order modulation and lower information densities to provide more reliable transmission of information over the communication link. Thus, while lower order coding and modulation schemes may be more reliable, they may also be less bandwidth efficient (e.g., less information may be transmitted per unit bandwidth per unit time). This may mean that, in order to maintain the availability of communications over the satellite communication network 100 in changing link conditions, service providers may have to change the amount of information transmitted to their subscribers per unit time.

Table 1 (below) provides a purely exemplary set of data to further clarify the trade-off between availability and bandwidth efficiency. As such, the data in Table 1 should not be construed as limiting the scope of the invention. Referring to Table 1, the leftmost column shows the availability of an exemplary communication system ranging from 99% to 99.99%. The remaining columns, from left to right, show metrics relating to the link margin, signal-to-noise ratio, coding and modulation scheme, and bandwidth efficiency of the exemplary communication system, respectively. As illustrated by Table 1, lower order coding and modulation schemes are used to increase availability of the network (i.e., the coding and modulation scheme is changed from 16APSK 3/4 to QPSK 3/4 to increase availability from 99% to 99.99%). The illustrative result shows a decrease in bandwidth efficiency from 2.97 to 1.32, almost a 60% decrease in bandwidth efficiency.

TABLE 1
Availability vs. Bandwidth Efficiency

| | | Operating | Selected Coding | |
|---|---|---|---|---|
| | Link Margin | Es/No | and Modulation | Bandwidth |
| Availability | (dB) | (dB) | Scheme | Efficiency |
| 99% | 0.53 | 10.67 | 16APSK ¾ | 2.97 |
| 99.9% | 2.33 | 8.87 | 8PSK ¾ | 2.23 |
| 99.99% | 7.19 | 4.01 | QPSK ¾ | 1.32 |

In some embodiments, the gateway 115 may further use hierarchical precoding schemes at least in part to mitigate the trade-off between availability and bandwidth efficiency. In certain embodiments, hierarchical precoding schemes may include simulcasting (simultaneously broadcasting) multiple versions of a set of source data (e.g., standard- and high-definition versions of a video stream). In other embodiments, hierarchical precoding schemes may include scalable precoding schemes, data partitioning schemes, and other precoding schemes, as described below. In certain embodiments, the hierarchically precoded data may be adaptively coded and/or modulated for transmission over the communication link in a layered fashion. In this way, it may be possible to affect either or both of availability and bandwidth efficiency per each hierarchical data layer, adding flexibility to the satellite communication system 100.

In certain embodiments, the gateway 115 may use either or both of ACM and hierarchical precoding schemes. In one example, multiple hierarchical layers are created, but a single coding and modulation scheme is used for all the layers. In another example, a single layer may be sent using multiple coding and modulation schemes. In other embodiments, the gateway 115 may precode, code, and/or modulate only a portion of the data. For example, the gateway 115 may detect that only enough bandwidth is available to transmit a single layer over the communication link. In this case, it may be efficient for the gateway 115 to generate only a single layer for some or all of the incoming source data.

A device connected to the network 120 may communicate with one or more subscriber terminals 130 through the gateway 115. Data and information, for example IP datagrams, may be sent from a device in the network 120 to the gateway 115. A variety of physical layer transmission modulation and coding techniques may be used with certain embodiments of the invention, including those defined with the DVB-S2 and WiMAX standards. In a number of embodiments, the gateway 115 utilizes ACM in conjunction with one or more hierarchical data precoding schemes described herein to direct traffic to the individual terminals. The gateway 115 may use a broadcast signal, with a modulation and coding format adapted for each packet to the link conditions of the terminal 130 or set of terminals 130 to which the packet is directed (e.g., to account for the variable service link 150 conditions from the satellite 105 to each respective terminal 130).

The gateway 115 may use an antenna 110 to transmit the signal or signals to the satellite 105. In one embodiment, the antenna 110 comprises a parabolic reflector with high directivity in the direction of the satellite and low directivity in other directions. The antenna 110 may be implemented in a variety of alternative configurations. The downstream signals may include, for example, a number of single carrier signals. Each signal carrier signal may be divided (e.g., using TDMA) into a number of virtual channels. The virtual channels may be the same size, or different sizes. In other embodiments, other channelization schemes may be used, such as Frequency Division Multiple Access (FDMA), Orthogonal Frequency Division Multiple Access (OFDMA), Code Division Multiple Access (CDMA), or any number of hybrid or other schemes known in the art.

In one embodiment, a geostationary satellite 105 is configured to receive the signals from the location of antenna 110 and within the frequency band and specific polarization transmitted. The satellite 105 may process the signals received from the gateway 115 and forward the signal from the gateway 115 to one or more subscriber terminals 130. In some embodiments, only a portion of the subscriber terminals 130 may be able to receive some or all of the signals due to certain link conditions.

In another embodiment, the satellite 105 operates in a multi-beam mode, transmitting a number of narrow beams each directed at a different region of the earth, allowing for frequency re-use. This satellite 105 may be configured as a “bent pipe” satellite, wherein the satellite may frequency convert the received carrier signals before retransmitting these signals to their destination, but otherwise perform little or no other processing on the contents of the signals. A variety of physical layer transmission modulation and coding techniques may be used by the satellite 105 in accordance with certain embodiments of the invention, including those defined with the DVB-S2 and WiMAX standards. For other embodiments, a number of configurations are possible (e.g., using LEO satellites, or using mesh networks instead of star networks), as known in the art.

The service signals 150 transmitted from the satellite 105 may be received by one or more subscriber terminals 130, via the respective subscriber antenna 125. The subscriber terminals 130 may receive the signals from the satellite 105 under very diverse link conditions. In certain embodiments, the subscriber terminals 130 may decode the received signals differently based on how they are received in different link conditions.

In one embodiment, the antenna 125 and terminal 130 together comprise a very small aperture terminal (VSAT). In other embodiments, a variety of other types of antennas 125 may be used at the subscriber terminal 130 to receive a signal. Each of the subscriber terminals 130 may comprise a single user terminal or, alternatively, a hub or router (not pictured) that is coupled to multiple user terminals. Each subscriber terminal 130 may be connected to consumer premises equipment (CPE) 160 comprising, for example computers, local area networks, Internet appliances, wireless networks, etc.

In one embodiment, a Multi-Frequency Time-Division Multiple Access (MF-TDMA) scheme is used for upstream links 140, 145, allowing efficient streaming of traffic while maintaining flexibility in allocating capacity among each of the subscriber terminals 130. In this embodiment, a number of frequency channels are allocated which may be fixed, or which may be allocated in a more dynamic fashion. A Time Division Multiple Access (TDMA) scheme is also employed in each frequency channel. In this scheme, each frequency channel may be divided into several timeslots that can be assigned to a connection (i.e., a subscriber terminal 130). In other embodiments, one or more of the upstream links 140, 145 may be configured with other schemes, such as FDMA, OFDMA, CDMA, or any number of hybrid or other schemes known in the art.

A subscriber terminal 130 may transmit information related to signal quality to the gateway 115 via the satellite 105. The signal quality may be a measured signal to noise ratio, an estimated signal to noise ratio, a bit error rate, a received power level, or any other communication link quality indicator. The subscriber terminal 130 itself may measure or estimate the signal quality, or it may pass information measured or estimated by other devices. This signal quality information may be used by the gateway 115 in some embodiments to adapt precoding schemes or coding and modulation schemes to match link conditions.

A subscriber terminal 130 may also transmit data and information to a network 120 destination via the satellite 105 and gateway 115. The subscriber terminal 130 transmits the signals via the upstream uplink 145 to the satellite 105 using the antenna 125. A subscriber terminal 130 may transmit the signals according to a variety of physical layer transmission modulation and coding techniques, including those defined with the DVB-S2 and WiMAX standards. In various embodiments, the physical layer techniques may be the same for each of the links 135, 140, 145, 150, or may be different.

The functions of the components of the satellite communication system 100 may be implemented in a number of different ways. For example, some or all of the functionality of the gateway 115 or the subscriber terminals 130 may be implemented in other components of the system, for example in the satellite 105. Further, many embodiments of gateways 115 and subscriber terminals 130 are possible according to the invention.

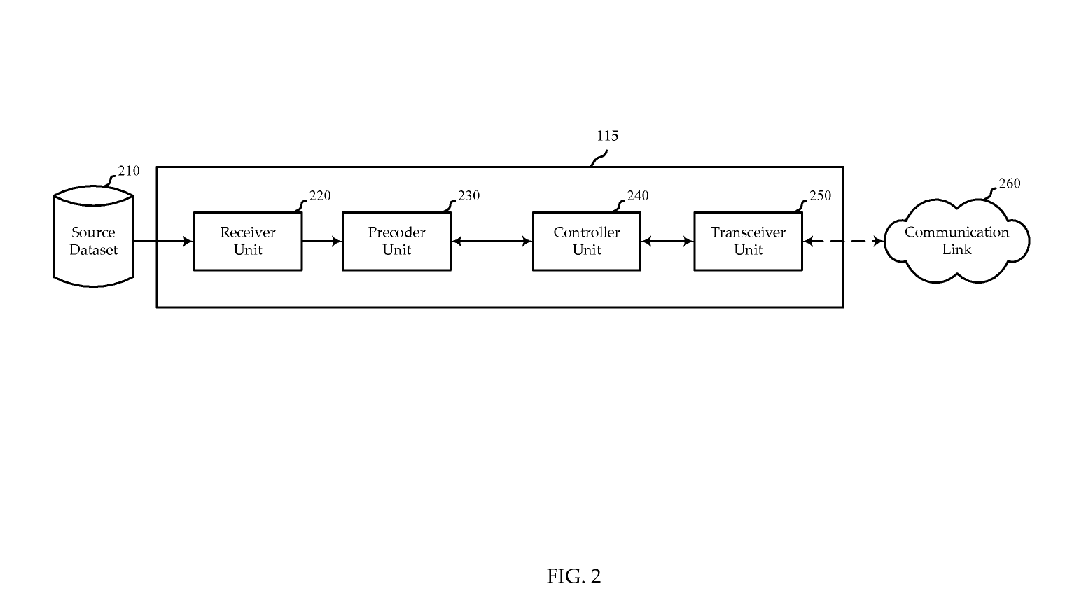

FIG. 2 provides a simplified block diagram of an embodiment of a gateway 115 configured according to various embodiments of the invention. In some embodiments, the gateway 115 transmits packets downstream to subscriber terminals 130 in a satellite communication system 100, as in FIG. 1. It is worth noting that the functionality of the gateway 115 may be implemented in any number of different ways.

In some embodiments, the gateway 115 includes a receiver unit 220, a precoder unit 230, a controller unit 240, and a transceiver unit 250. The gateway 115 may receive a set of source data 210, process the data using various components, and transmit the data over a communication link 260.

In some embodiments, the gateway 115 includes the receiver unit 220, which receives the set of source data 210. The set of source data 210 may include, for example, audio data, video data, voice data, or any other type of data. The receiver unit 220 may include any hardware, software, or other components necessary to receive the set of source data 210. For example, the receiver unit 220 may include amplifiers, buffers, ports, codecs, etc. In one embodiment, the set of source data 210 includes an audio-visual data stream, which is received by the receiver unit 220 from a data network through a data port.

The receiver unit 220 may pass all or a portion of the set of source data 210 to the precoder unit 230. The precoder unit 230 may precode the portion of the set of source data 210 to generate sets of representation data. The sets of representation data may contain any type of information, including information extracted or adapted from the set of source data 210, which is useful for generating a representation of the set of source data 210. For example, a set of representation data may contain enough information extracted from a source video stream to allow the generation of a lower-resolution version of the video stream. In another example, the set of representation data may include color or texture information, which may be added to other sets of representation data to generate an enhanced version of the source video stream.

In certain embodiments, the precoder unit 230 applies certain precoding schemes, including scalable precoding schemes, data partitioning schemes, etc. In one embodiment, where the set of source data 210 includes an audio-visual data stream, the precoder unit 230 may precode the audio-visual data stream into various hierarchical sets of representation data by using the scalable capabilities of the MPEG-4 standard. In another embodiment, where the set of source data 210 includes an audio-visual data stream, the precoder unit 230 may precode the audio-visual data stream into various hierarchical sets of representation data by using the data partitioning capabilities of the H.264 adaptive video coding standard. Embodiments of precoding schemes are described more fully below.

In some embodiments, multiple precoding schemes may, in reality, be implemented as multiple functions of a single precoding scheme. In one embodiment, multiple scalable precoding schemes are implemented by using a single MPEG-4 precoding algorithm to generate multiple layers of output (i.e., the generation of a base layer and enhancement layers using MPEG-4 may be inextricably linked). In another embodiment, multiple data partitioning precoding schemes are implemented by using one data partitioning algorithm to slice the set of source data 210 into multiple data partitions. As such, it will be appreciated that phrases like “multiple precoding schemes” and “a first precoding scheme” should be broadly construed to encompass at least single precoding schemes capable of producing multiple different outputs.

The sets of representation data may be passed from the precoder unit 230 to the controller unit 240, which may associate each set of representation data with a coding and modulation scheme. For example, a first set of representation data may correspond to first-level (e.g., low resolution) playback of the set of source data 210, and a second set of representation data may correspond to second-level (e.g., higher resolution, enhanced) playback of the same set of source data 210. The controller unit 240 may associate the first set of representation data with a lower order coding and modulation scheme (e.g., quadrature phase-shift keying with 1-to-4 forward error correction (QPSK 1/4)) to better ensure the transmission of data for at least first-level playback. The controller unit 240 may associate the second set of representation data with a higher order coding and modulation scheme (e.g., 8PSK 7/8), reducing the transmission reliability of less critical enhancements for savings in power and bandwidth. Embodiments of coding and modulation schemes are described more fully below.

In some embodiments, the controller unit 240 may be configured to control all or some of the operations of the precoder unit 230. For example, the controller unit 240 may determine certain parameters which the precoder unit 230 may use to precode the set of source data 210. In one embodiment, the controller unit 240 determines a set of scaling parameters for the precoder unit 230 to use with a scalable precoding scheme to generate sets of representation data. It will be appreciated that the controller unit 240 may determine how to control the precoder unit 230 based on different types of information. For example, the controller unit 240 may receive information relating to link conditions, as described more fully below.

The controller unit 240 may pass the coded and/or modulated data to a transceiver unit 250. The transceiver unit 250 may process the data into one or more signals for transmission (e.g., by buffering or amplifying the data), and may pass the signal to a communication link 260. The transceiver unit 250 may include any hardware, software, or other components necessary to transmit the signals or to interface with the communication link 260.

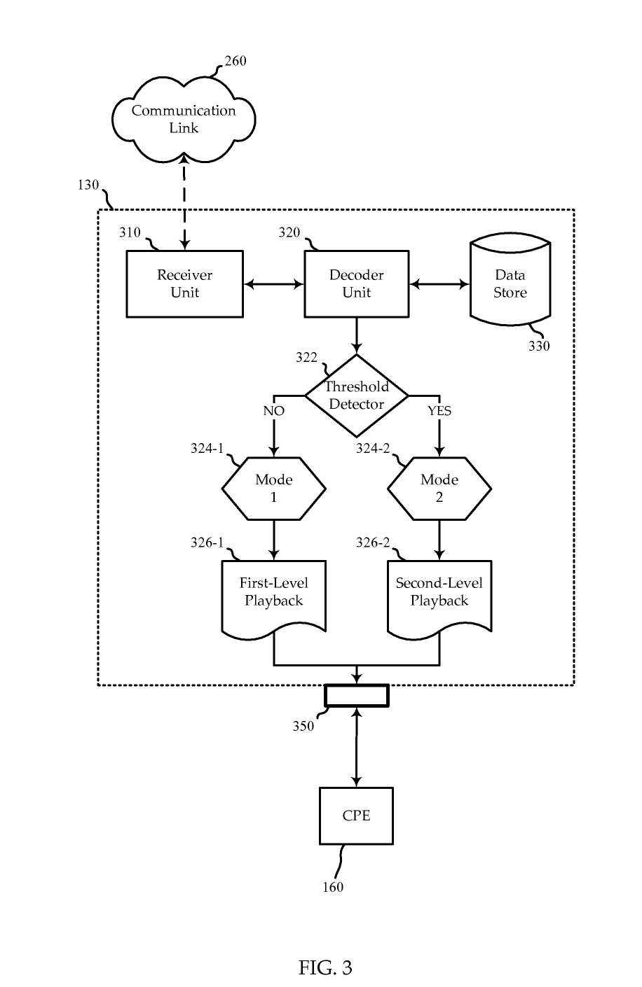

In some embodiments, signals are transmitted by the gateway 115 over the communication link 260 to one or more subscriber terminals 130. FIG. 3 provides a simplified block diagram of an embodiment of a subscriber terminal 130 according to various embodiments of the invention. The subscriber terminal 130 may receive signals from the communications link 260 and decode the signals, for example for playback. As shown in FIG. 1, the subscriber terminal 130 may receive signals from a service link 150 via an antenna 125.

In some embodiments, signals are received by the subscriber terminal 130 at a receiver unit 310. The receiver unit 310 may include any hardware, software, or other components necessary to receive the signals. The received signals may include the sets of representation data generated by the gateway 115 and transmitted by the transceiver unit 250 in FIG. 2. Depending on various link conditions, some sets of representation data may not be reliably received.

In poor link conditions (e.g., heavy rain), higher order coding and modulation schemes may fail to provide reliable signal transmission over the communication link 260. For example, signals may be corrupted in transmission, arriving at the subscriber terminal 130 with low power, high bit error rates, low signal-to-noise ratios, etc. As such, in certain link conditions, sets of representation data transmitted using lower order coding and modulation schemes may be reliably transmitted to the subscriber terminal 130, while other sets of representation data may fail to be reliably transmitted.

Received signals may be passed to a decoder unit 320 for decoding. It will be appreciated that certain amounts and types of data may need to be extracted from the signals to permit decoding. Thus, signals which fail to be reliably received by the receiver unit 310 may also fail to be decoded reliably by the decoder unit 320. Of course, the decoder unit 320 may include any hardware, software, or other components helpful for decoding data in various conditions. For example, the decoder unit 320 may have access to various error correction, de-multiplexing, formatting, and other routines.

In some embodiments, the subscriber terminal 130 may be capable of decoding received signals in multiple modes 324. The modes 324 may relate, for example, to decoding for different levels of playback. In certain embodiments, modes 324 may be determined based in part on which sets of representation data are received, and whether enough data from those sets is reliably received, so the data may be decoded by the decoder unit 320. When sufficient data is received from a particular set of representation data, the mode 324 may switch to utilize that data. The subscriber terminal 130 may use one or more of the modes 324 as a default, and be able to switch to other modes 324 either manually or automatically.

In some embodiments, the decoder unit 320 includes a threshold detector 322, which detects whether enough data is being reliably received to allow the decoder unit 320 to provide higher level playback. Because different sets of representation data may be transmitted using different coding and modulation schemes, some sets of representation data (e.g., those transmitted with higher order coding and modulation schemes) may fail to be reliably received by the subscriber terminal 130 under certain link conditions. Depending on whether the threshold is being met, the decoder unit 320 may be configured to provide different levels of playback by decoding signals in different modes 324.

In one embodiment, a first set of representation data (representing low level playback of a set of source data) is transmitted with a very low order coding and modulation scheme. In this way, the first set of representation data may almost always be reliably received by the subscriber terminal 130. The reliable receipt of the first set of representation data also means that the decoder unit 320 may almost always be able to decode sufficient information to generate a set of low level playback data. As such, the decoder unit 320 may be configured to operate by default in a first mode 324-1. In this first mode 324-1, the decoder unit 320 may decode only those signals which provide the first set of representation data, providing a subscriber with the ability for low level playback 326-1 at almost all times.

In this embodiment, at times, signals are received by the subscriber terminal 130 which contain a second set of representation data. This second set of representation data (representing high level playback of a set of source data) may be transmitted with a higher order coding and modulation scheme, making its receipt less reliable in some link conditions. The threshold detector 322 may monitor the received signals to determine whether some threshold amount of the second set of representation data is being reliably received. When the threshold amount of the second set of representation data is not being reliably received, the subscriber terminal 130 may remain in mode 1 324-1. When the threshold detector 322 detects that the threshold amount of the second set of representation data is being reliably received, the subscriber terminal 130 may enter mode 2 324-2. In mode 2 324-2, the decoder unit 320 may generate a set of second-level playback data 326-2.

It will be appreciated that other numbers and types of modes 324 are possible, and the modes 324 may be implemented in different ways. Further, modes 324 may be selected manually, or as a result of other conditions, and may be implemented in hardware or software.

The decoder unit 320 may generate a set of playback data 326 to allow different levels of playback of the source data. The generated set of playback data 326 may be output to consumer premises equipment 160 (e.g., a television), for example, through a port 350. It will be appreciated that the set of playback data 326 may be further processed or other hardware, software, etc. may be provided to interface with different types of ports 350 and/or consumer premises equipment 160.

In other embodiments, the subscriber terminal 130 may include a data store 330, which may be communicatively coupled with the decoder unit 320. The subscriber terminal 130 may be configured to save data decoded by the decoder unit 320 in the data store 330 either all the time or on certain conditions. In one embodiment, a subscriber manually selects times when data should be stored in the data store 330 for later playback.

In certain embodiments, data is automatically stored in the data store 330 based on the signal quality of the received signals. At certain times (e.g., in certain weather, because of bandwidth constraints, or due to other link conditions), only a portion of the sets of representation data relating to a particular set of source data may be reliably received by the subscriber terminal 130. At these times, it may be desirable to accumulate related data in the data store 330 as it is received. It will be appreciated that many ways to accumulate related data in the data store 330 are known in the art. For example, a relational database may be used, which stores each decoded dataset in relation to the set of source data to which it relates. In these embodiments, it may be possible to store the first set of representation data while link conditions are poor, and wait to receive additional sets of representation data when link conditions improve.

In some embodiments, the subscriber terminal 130 may generate notifications relating to which sets of representation have been received, decoded, and/or stored. In one embodiment, a subscriber may set the subscriber terminal 130 to automatically generate a notification when at least two sets of representation data have been stored in the data store 330 relating to a particular set of source data. In another embodiment, the subscriber terminal 130 may periodically send notifications to a service provider requesting transmission (or re-transmission) of certain sets of representation data. For example, if a set of representation data fails to be reliably received, the subscriber terminal 130 may notify the sender to retransmit the set of representation data, possibly using a lower mode coding and modulation scheme.

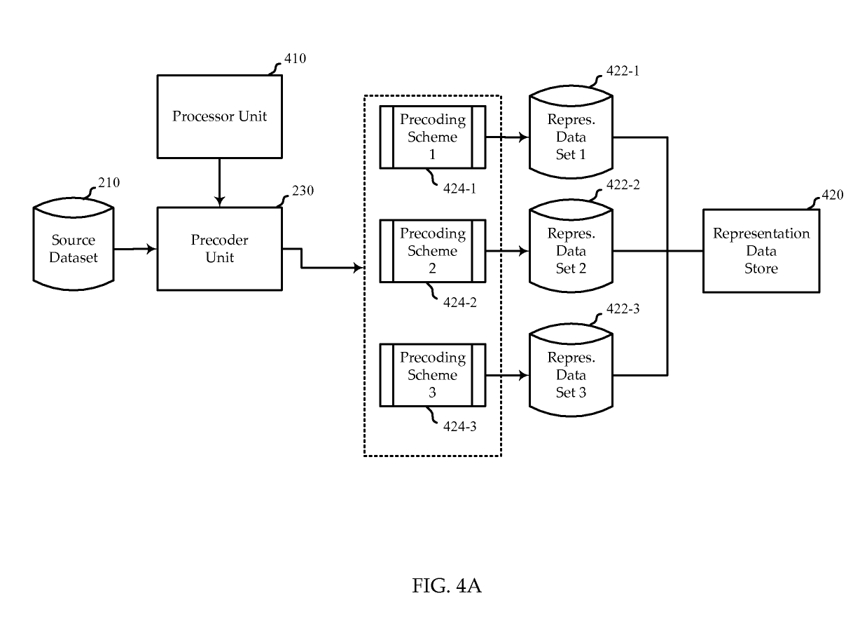

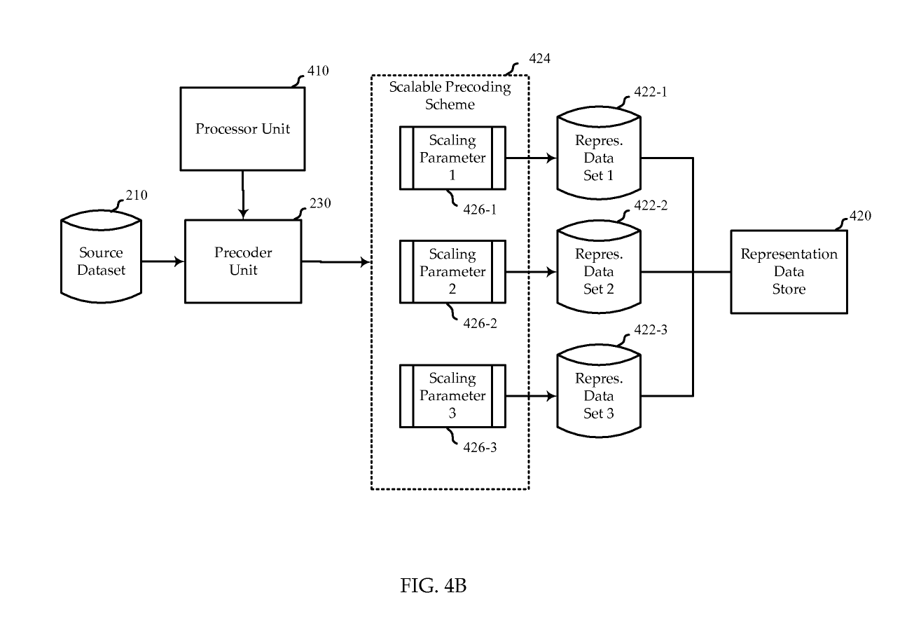

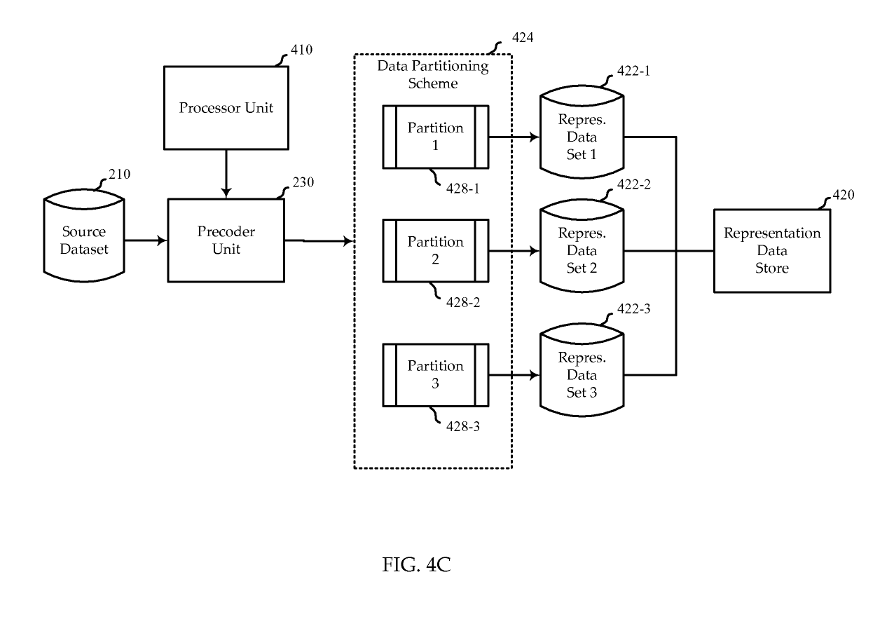

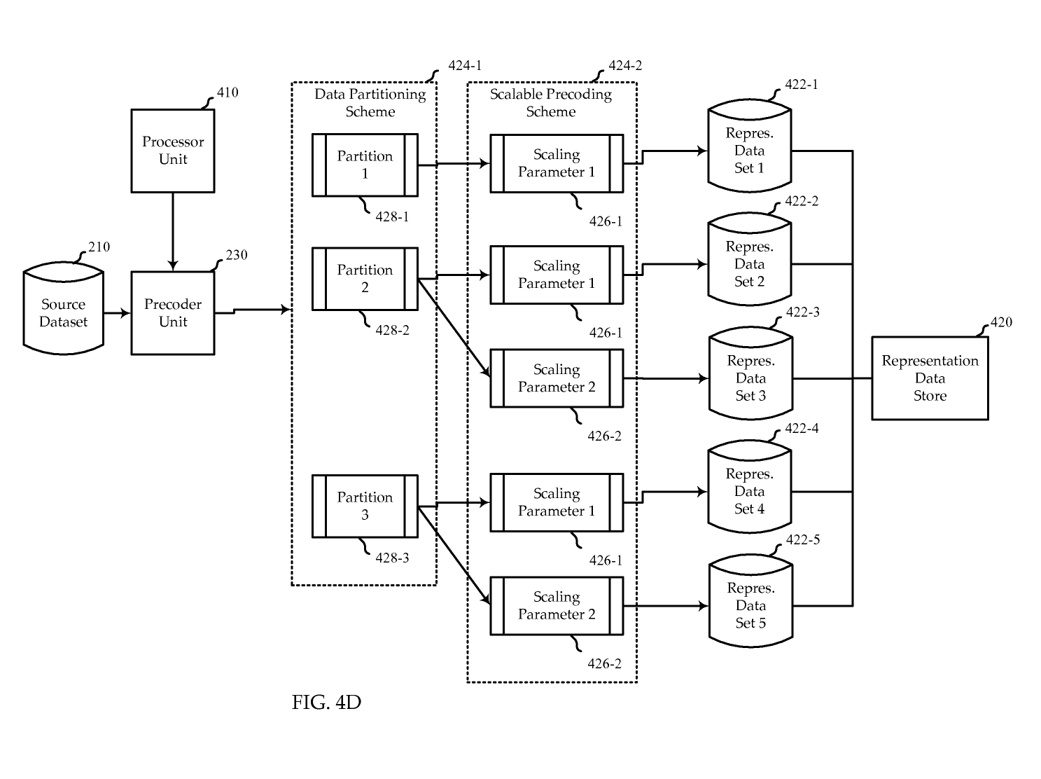

It will now be appreciated that many embodiments and configurations of the gateway 115 and the subscriber terminals 130 are possible according to the invention. These various embodiments may be further understood with regard to various block diagrams, like those shown in FIGS. 4-8. It will be appreciated that while components and functions are described with relation to the gateway 115, the various functions may be implemented in many ways according to the invention. As such, the block diagrams are purely illustrative and should not be construed as limiting the scope of the invention.

Turning to FIG. 4A, a functional block diagram incorporating a precoder unit 230 according to various embodiments of the invention is provided. In some embodiments, a set of source data 210 passes to the precoder unit 230. The precoder unit 230 may precode the set of source data 210 using any number and/or type of precoding scheme 424.

Preferably, each precoding scheme 424 is different from each other precoding scheme 424 in some way, generating hierarchal (or layered or partitioned) output. Purely by way of example, some or all of the different precoding schemes 424 may use different codecs, parameters, transformations, transcoding, algorithms, and other techniques to affect resolution, quantization, bit rate, temporality, quality, spatiality, complexity, or any other useful characteristic of the data.

In some embodiments, the precoder unit 230 is communicatively coupled with a processor unit 410. In some embodiments, the processor unit 410 may be part of the controller unit 240 of FIG. 2. In other embodiments, the processor unit 410 may be incorporated into the precoder unit 230. In still other embodiments, the processor unit 410 may be implemented as a separate component or in any other useful way. In certain embodiments, the processor unit 410 may control all or part of the functionality of the precoder unit 230. For example, where the precoder unit 230 precodes the set of source data 210 based on certain parameters, the processor unit 410 may perform functions, including generating or selecting the parameters, instructing the precoder unit 230 to use the parameters, etc.

In one embodiment, three precoding schemes (424-1, 424-2, and 424-3) are used to generate three sets of representation data (422-1, 422-2, and 422-3), respectively. The three sets of representation data (422-1, 422-2, and 422-3) may correspond to three hierarchical layers of representation of the set of source data 210. Each of these sets of representation data 422 may be stored in a representation data store 420.

Further embodiments of the functionality in FIG. 4A are illustrated in the exemplary functional block diagrams of FIGS. 4B-4D. FIG. 4B provides a functional block diagram of a set of embodiments incorporating a precoder unit 230 using scalable precoding schemes 424 according to various embodiments of the invention.

In this set of embodiments, a set of source data 210 passes to the precoder unit 230. The precoder unit 230 precodes the set of source data 210 using a scalable precoding scheme 424. Scalable precoding schemes 424 may divide the set of source data 210 into different hierarchical layers. In some embodiments, a first (lowest-level) layer is called the base layer and higher layers are called enhancement layers. A scalable precoding scheme 424 may intend to achieve graceful degradation of the picture quality. For example, by providing the capability to playback data at a number of different levels, the precoding scheme 424 may avoid suffering from the “all or nothing” effect observed in some non-scalable coding systems.

In some embodiments, the scalable precoding scheme 424 may exploit different compression techniques to produce bit streams that are decodable at different bit rates. In one embodiment, a base layer contains the most critical information for playback that is determined to be “good enough” for a consumer. In this embodiment, enhancement layers may contain less critical information, like higher color depths, texturing, or resolution. Using this precoding scheme 424, it may be possible to provide a consumer with more reliable access to the base layer, such that a “good enough” level of playback is almost always available.

It will be appreciated that various types of scalability may be used. Purely by way of example, scalabilities may include quality, temporal, spatial and complexity scalability, in order to accommodate heterogeneous networks, different devices, various link conditions, or other communication environments. Among these scalabilities, various spatial and temporal scalable precoding schemes 424 may be known in the art, such as MPEG-2, MPEG-4 and H.263++. In addition, certain fine-granularity scalable (FGS) precoding schemes 424 may be known in the art. For example, MPEG-4 standard (Part-2) may incorporate a FGS technique with the precoder unit 230 using the motion-compensated discrete cosine transform (DCT) to generate a base layer as the lowest-level layer. Residual information between the original image and the reconstructed base layer image may be used to form one or more enhancement layers. An enhancement layer may be generated with a bit plane coding technique, which may provide fine granularity quality and temporal scalabilities.

Further, in certain embodiments, scalable precoding schemes 424 may provide error correction capabilities. For example, the MPEG-4 standard (Part-2) may be used to predict base layers and enhancement layers of future frames by using data from present frames. Using predicted data in the context of received data may allow correction of any bit stream truncation or lost packets, and may allow future frames to be more reliably recreated.

Regardless of the type or types of scalable precoding schemes 424 used, it may be preferable for each precoding scheme 424 to provide different scaling results for generating hierarchal output. Further, in some embodiments, the precoder unit 230 may be communicatively coupled with a processor unit 410, such that the processor unit 410 may control all or part of the functionality of the precoder unit 230. For example, the processor unit 410 may be configured to generate or select scaling parameters.

In one embodiment, one precoding scheme 424 is used with three scaling parameters (426-1, 426-2, and 426-3) to generate three sets of representation data (422-1, 422-2, and 422-3), respectively. The three sets of representation data (422-1, 422-2, and 422-3) may correspond to three hierarchical layers of representation of the set of source data 210. For example, the first set of representation data 422-1 may include base layer information, while the other two sets of representation data (422-2 and 422-3) may include enhancement layer information. Each of these sets of representation data 422 may be stored in a representation data store 420.

FIG. 4C provides a functional block diagram illustrating a set of embodiments of a precoder unit 230 using data partitioning precoding schemes 424 according to various embodiments of the invention. In this set of embodiments, a set of source data 210 passes to the precoder unit 230. The precoder unit 230 precodes the set of source data 210 using data partitioning precoding schemes 424. Data partitioning precoding schemes 424 may divide the set of source data 210 into different partitions.

Various data partitioning precoding schemes 424 may be known in the art. For example, data partitioning capabilities may be included in the H.264/AVC (adaptive video coding) standard. According to this standard, the precoder unit 230 may divide the set of source data 210 into three separate data partitions 428.

In one embodiment, three data partitions 428 may be defined to provide different levels of information representing the set of source data 210. A first partition 428-1 may contain syntax elements from header information within the set of source data 210, including macroblock types, quantization parameters, and motion vectors. A second partition 428-2 may contain intra-coded block patterns and transform coefficients. The second partition 428-2 may, for example, use various spatial prediction modes to exploit spatial statistical dependencies in the set of source data 210 for a single video frame. A third partition 428-3 may contain inter-coded block patterns and transform coefficients. The third partition 428-3 may, for example, use motion vectors for block based inter prediction to exploit block-shaped regions of each video frame in the set of source data 210.

The information contained in the first partition 428-1 (e.g., the header information of the set of source data 210) may represent a small portion of the set of source data 210, but it may be very critical to the recreation of the set of source data 210. For example, a “good enough” (or even a relatively high-quality) representation of the set of source data 210 may be recreated from only the information contained in the first partition 428-1, like macroblock types and motion vectors. On the contrary, information contained in the second partition 428-2 and the third partition 428-3 may be less critical while representing larger portions of the set of source data 210. Further information contained in the second partition 428-2 and the third partition 428-3 may be useful only in conjunction with information from the first partition 428-1.

It will be appreciated that other numbers and types of partitions are possible. Further, other steps may be required or desired as part of data partitioning precoding schemes 424. Regardless of the type or types of data partitions 428 used, it may be preferable for each precoding scheme 424 to use those data partitions 428 to provide hierarchal output. Further, in some embodiments, the precoder unit 230 may be communicatively coupled with a processor unit 410, such that the processor unit 410 may control all or part of the functionality of the precoder unit 230. For example, the processor unit 410 may be configured to generate or select data partitions 428.

In one embodiment, one data partitioning precoding schemes 424 is used with three data partitions 428 (428-1, 428-2, and 428-3) to generate three sets of representation data (422-1, 422-2, and 422-3), respectively. The three sets of representation data (422-1, 422-2, and 422-3) may correspond to three hierarchical partitions of the set of source data 210. For example, the first set of representation data 422-1 may include critical header information, while the other two sets of representation data (422-2 and 422-3) may include less critical intra- and inter-coded block patterns and transform coefficients. For example, using the H.264/AVC standard, the data partitions 428 may be encapsulated into separate network abstraction layer (NAL) packets, which may be collated into the sets of representation data 422. Each of these sets of representation data 422 may be stored in a representation data store 420.

FIG. 4D provides functional block diagram of a set of embodiments incorporating a precoder unit 230 using hybrid scalable and data partitioning precoding schemes 424 according to various embodiments of the invention. In this set of embodiments, the precoder unit 230 precodes the set of source data 210 using a combination of scalable and data partitioning precoding schemes 424.

In various embodiments, the scalable precoding schemes 424-2 and the data partitioning precoding schemes 424-1 may be used in different orders to provide the same or different results. In one embodiment, the scalable precoding schemes 424-2 may create base and enhancement layers of the set of source data 210, and the data partitioning precoding schemes 424-1 may divide some or all of those layers into different partitions. In another embodiment, the data partitioning precoding schemes 424-1 may divide the set of source data 210 into a number of partitions, which may then be layered using the scalable precoding schemes 424-2.

It will be appreciated that various scalable and data partitioning precoding schemes 424 may be known in the art. Further, it will be appreciated that different types of precoding schemes 424 may manifest various drawbacks. For example, many data partitioning precoding schemes 424-1 (e.g., H.264/AVC) may lack flexibility in the creation of data partitions 428. Additionally, many scalable precoding schemes 424-2 (e.g., FGS) may degrade compression efficiencies. Some combinations of precoding schemes 424 may be able to minimize some of these drawbacks.

In the embodiment shown in FIG. 4D, a set of source data 210 passes to the precoder unit 230. The precoder unit 230 may use data partitioning precoding schemes 424-1 to divide the set of source data 210 into three data partitions (428-1, 428-2, and 428-3). The precoder unit 230 may then apply scalable precoding schemes 424-1 to each of the three data partitions (428-1, 428-2, and 428-3).

In one embodiment, H.264/AVC data partitioning precoding schemes 424-1 are used to generate the three data partitions (428-1, 428-2, and 428-3). For example, as described above with respect to FIG. 4C, the first partition 428-1 may contain critical header and other information, while the second partition 428-2 and the third partition 428-3 may contain less critical DCT information. Each of the three data partitions (428-1, 428-2, and 428-3) may then be passed to MPEG-4 scalable precoding schemes 424-2, configured with a first scaling parameter 426-1 and a second scaling parameter 426-2.

In this embodiment, the first partition 428-1 may be further precoded, using the first scaling parameter 426-1, thereby generating a first set of representation data 422-1. The second partition 428-2 may be further precoded into two layers, using both scaling parameters (426-1 and 426-2), thereby generating second and third sets of representation data (422-2 and 422-3). The third partition 428-3 may also be further precoded into two layers, using both scaling parameters (426-1 and 426-2), thereby generating fourth and fifth sets of representation data (422-4 and 422-5). It will be appreciated that further precoding the second and third data partitions (428-2 and 428-3) may create layers based on any useful characteristic of the partitioned data. For example, the base layers of the data partitions (e.g., what generated the second and fourth sets of representation data (422-2 and 422-4)), may contain coarsely quantized DCT coefficients, while the enhancement layers of the data partitions (e.g., what generated the third and fifth sets of representation data (422-3 and 422-5)), may contain refinement information from which a finer quantization can be obtained.

In some embodiments, the precoder unit 230 may be communicatively coupled with a processor unit 410, such that the processor unit 410 may control all or part of the functionality of the precoder unit 230. In certain embodiments, the processor unit 410 may be configured to generate or select data partitions 428. In other embodiments, the processor unit 410 may be configured to generate or select scaling parameters 426. In still other embodiments, the processor unit 410 may be configured to generate or select both data partitions 428 and scaling parameters 426. It will be appreciated that the processor unit 410 may be utilized in many ways to add capabilities and flexibility to the functionality of the precoder unit 230. For example, the data partitioning and layering may be adjusted flexibly according to system throughput requirements and link conditions. To achieve greater flexibility, the precoding schemes 424 may be configured to dynamically change numbers and types of data partitions 428, numbers and types of scaling parameters 426, etc.

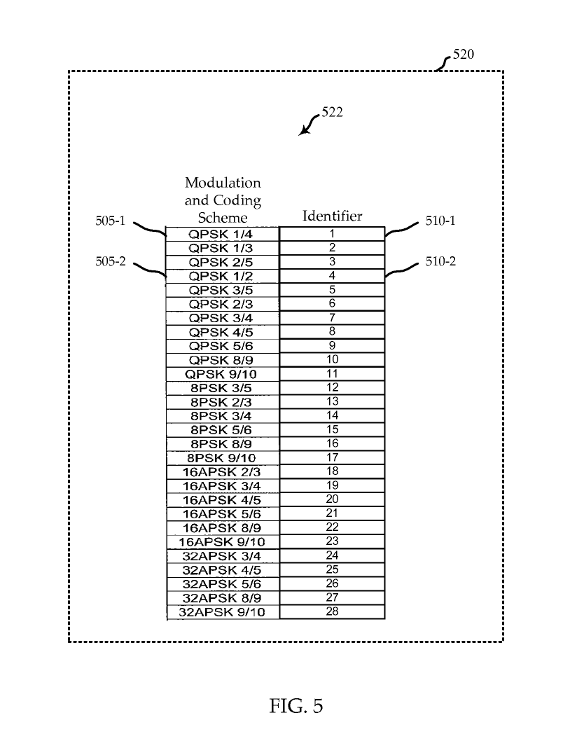

In addition to the many functions and capabilities of the precoder unit 230, various embodiments may provide many different coding and modulation capabilities. FIG. 5 provides an illustration of an exemplary table of identifier data 522 for use with various embodiments of the invention. The entries in the table of identifier data 522 show some possible coding and modulation schemes 505 and their associated identifiers 510. It will be appreciated that many types of coding and modulation are possible according to the invention. As such, the coding and modulation schemes 505 listed in the table of identifier data 522 are for illustrative purposes only and should not be construed as limiting the scope of the invention.

Each identifier 510 is associated with a coding and modulation scheme 505. For example, identifier “1” 510-1 is associated with a first coding and modulation scheme 505-1, representing quadrature phase shift keying with a one-to-four forward error correction (FEC) rate (QPSK 1/4). In some embodiments, each identifier 510 may be a pointer to a set of information (e.g., an algorithm or a set of parameters) needed to implement its associated coding and modulation scheme 505.

According to the table of identifier data 522, a shift from identifier “1” 510-1 to identifier “4” 510-2 maintains the same modulation order (QPSK) while increasing the information density of the FEC (from 1/4 to 1/2). The coding and modulation scheme 505-2 associated with identifier “4” 510-2 generates half as many error correction bits for each information bit as does the coding and modulation scheme 505-1 associated with identifier “1” 510-1.

It will be appreciated that different implementations may use different types of coding and modulation schemes 505. It will further be appreciated that different tables of identifier data 522 may be configured to have different margins between the coding and modulation schemes 505 or to associate the identifiers 510 differently. For example, a table of identifier data 522 may include only every third entry shown on the table of identifier data 522 in FIG. 5. It will further be appreciated that the table of identifier data 522 may include other types of data for various reasons, like signal quality indicators (e.g., measured signal to noise ratio, estimated signal to noise ratio, bit error rate, received power level, etc.).

When link conditions are poor (e.g., low signal-to-noise ratio), lower order modulation schemes and low information densities may be required for reliable delivery of data. This may result in fewer data bits being sent per unit time as well as inefficient uses of power and bandwidth. When link conditions are good, higher order modulation schemes may be used with higher information density. This may allow more data bits to be sent per unit time with more efficient usage of power and bandwidth.

In many communication systems, the situation may be complicated by the fact that data is being sent to multiple subscribers with different characteristics (e.g., in different geographic locations, having different receiving capabilities, having different entitlement levels, etc.). When data packets are addressed to a single terminal (unicast), the packets may be sent using the most efficient coding and modulation scheme 505 that the communication link will support. However, when data packets are addressed to many receivers (multicast or broadcast), the packets may have to be sent using the coding and modulation scheme 505 that the receiver with the worst link in the group can support. When link conditions affect only a portion of the subscribers (e.g., a localized rain fade), this may result in inefficient network usage. Thus, link conditions may change dynamically per unit time, per subscriber, or based on other parameters.

By using certain adaptive coding and modulation (ACM) techniques, coding and modulation schemes 505 may be dynamically selected to match changing link conditions. In one embodiment, coding and modulation schemes 505 are selected by using the identifiers 510 and the table of identifier data 522. The coding and modulation schemes 505 are then encapsulated, coded, mapped, and transmitted in any of a variety of ways, as known in the art. ACM is then implemented using the DVB-S2 standard, which specifically provides for its use. It will be appreciated that other implementations are possible, for example, including systems using DOCSIS or WiMax.

In some embodiments, the table of identifier data 522 and any other related information may be stored in an identifier store 520. The identifier store 520 may store the table of identifier data 522 in any useful way. For example, the table of identifier data 522 may be hard-wired into a microchip, or stored as a flat file or a relational database.

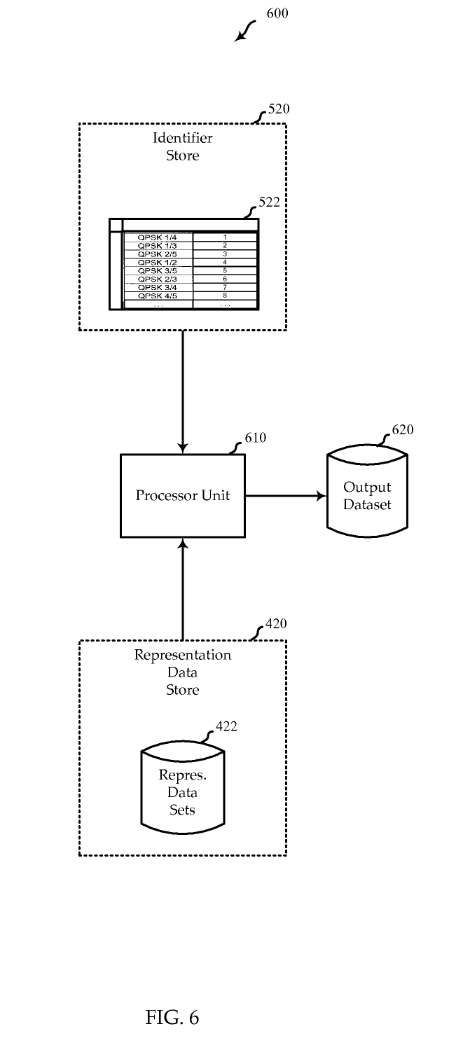

FIG. 6 provides a functional block diagram of a device 600 incorporating a processor unit 610, a representation data store 420, and an identifier data store 520 according to various embodiments of the invention. In some embodiments, the device may be or may include the controller unit 240 of FIG. 2.

In some embodiments, the processor unit 610 is communicatively coupled with the representation data store 420 and the identifier data store 520. The representation data store 420 may be configured to store sets of representation data 422 and the identifier data store 520 may be configured to store a table of identifier data 522. In certain embodiments, the processor unit 610 may be configured to process data from both the representation data store 420 and the identifier data store 520 to generate a set of output data 620. In other embodiments, the processor unit 610 may be configured to control at least a portion of the generation or processing of the data stored in either or both of the representation data store 420 and the identifier data store 520.

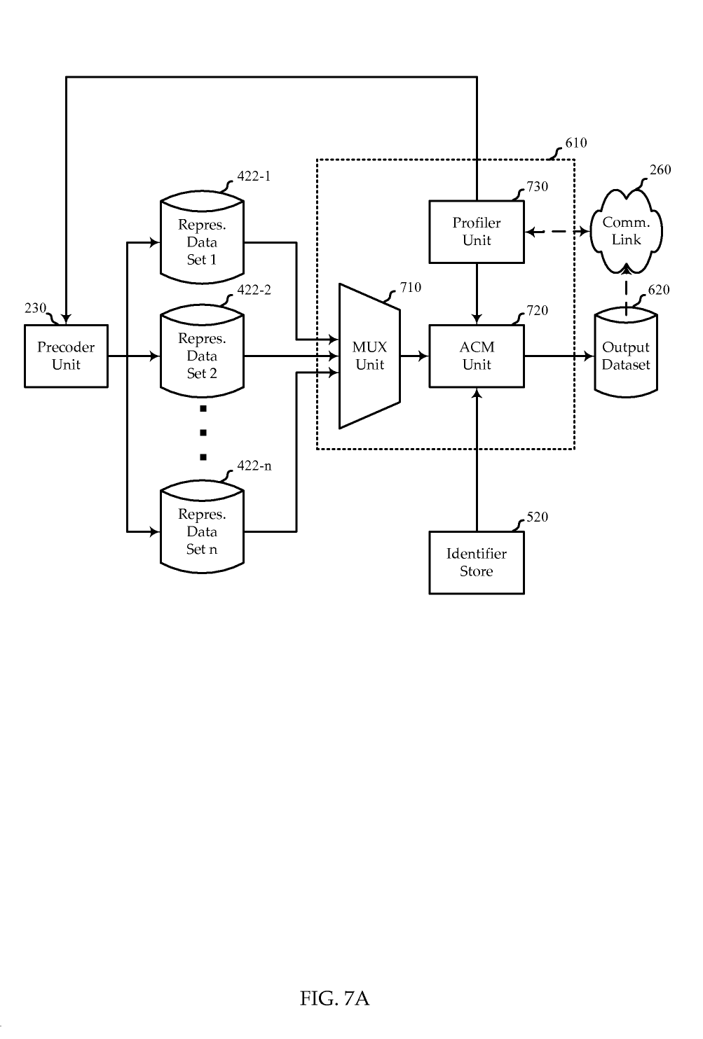

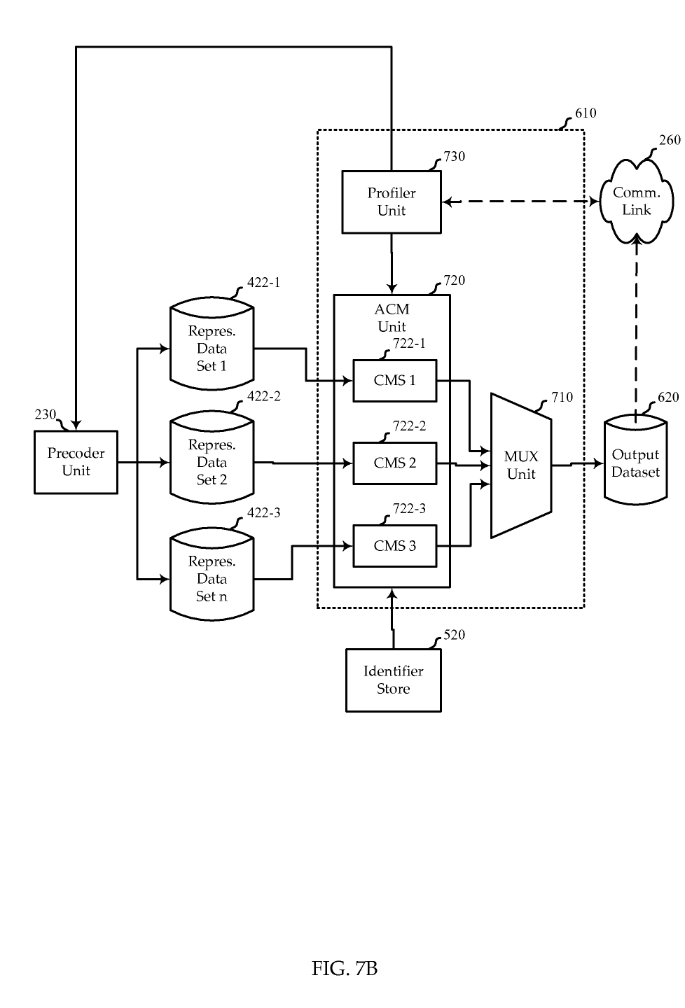

The capabilities and functionality of the processor unit 610 are discussed further in FIGS. 7A and 7B. FIG. 7A provides a functional block diagram incorporating a processor unit 610 according to various embodiments of the invention. In some embodiments, the processor unit 610 is the same as or is part of the controller unit 240 of FIG. 2. The processor unit 610 may receive sets of representation data 422 from the precoder unit 230 and identifier data from the identifier data store 520.

In some embodiments, the processor unit 610 may receive sets of representation data 422 from the precoder unit 230. The sets of representation data 422 may pass through a multiplexer unit 710. The multiplexer unit 710 may multiplex the data in any useful way, for example, by time division multiplexing (TDM), frequency division multiplexing (FDM), wavelength division multiplexing (WDM), code division multiplexing (CDM), polarization, or any other effective technique.

The multiplexer unit 710 may be communicatively coupled with an adaptive coding and modulation (ACM) unit 720. The ACM unit 720 may be further communicatively coupled with an identifier data store 520 and configured to receive identifier data stored at the identifier data store 520. Using the identifier data, the ACM unit 720 may implement ACM on the multiplexed data coming from the multiplexer unit 710 to generate a set of output data 620.

In one embodiment, the ACM unit 720 is implemented as a single module, which is configured to accept only a single stream of data. In this embodiment, the purpose of the multiplexer unit 710 may be to produce serial data for use by the single-stream ACM unit 720. Packets of information belonging to sets of representation data 422 coming from the precoder unit 230 may be tagged with information that represents to which of the sets of representation data 422 each packet belongs. For example, packets of data may be appended with header information that includes a designator number representing a particular set of representation data 422. Using the tags, the multiplexer unit 710 may multiplex the data from the multiple sets of representation data 422 to produce a single stream of data for the ACM unit 720.

In another embodiment, the set of source data (not shown) received by the precoder unit 230 includes data for multiple source programs (e.g., multiple video streams). At times (e.g., when link conditions are substantially static), the precoder unit 230 may be configured to precode each of the multiple source programs into the same sets of representation data 422, using the same precoding schemes. For example, a set of source data for a first program and a set of source data for a second program may each be precoded into a base layer and an enhancement layer. The multiplexer unit 710 may multiplex the two base layers (i.e., one from each program) into one data stream and multiplex the two enhancement layers into a second data stream. The two data streams each may then pass to the ACM unit 720.

In some embodiments, the ACM unit 720 generates a set of output data 620. The set of output data 620 may include one or more signals configured to be transmitted over a communication link 260. The signal or signals may be coded and/or modulated as dictated by the ACM unit 720. Further, the signal or signals may be coded and/or modulated in any additional way or combination of ways for transmission over the communication link 260. It will be appreciated that one or more signals may not be included in the set of output data. For example, at times when insufficient bandwidth is available for sending multiple signals, the output data may include only one signal or only one set of representation data 422.

It will be appreciated that the processor unit 610 may be configured in different ways according to the invention. For example, turning to FIG. 7B, another functional block diagram incorporating a processor unit according to various embodiments of the invention is provided. In the embodiments of FIG. 7B sets of representation data 422 coming from the precoder unit 230 pass through the ACM unit 720 before they are multiplexed by the multiplexer unit 710. Three sets of representation data (422-1, 422-2, and 422-3) may pass to the ACM unit 720. The ACM unit 720 may then use three coding and modulation schemes (722-1, 722-2, and 722-3), one on each of the three sets of representation data (422-1, 422-2, and 422-3). The three coding and modulation schemes (722-1, 722-2, and 722-3) may generate three output signals, which are multiplexed by the multiplexer unit 710 to generate a set of output data 620 containing a single multiplexed signal. This signal may then be transmitted over the communication link 260.

Other configurations may also be possible according to the invention. In some embodiments, the ACM unit 720 may include a channel coding unit and a modulation unit. In one embodiment, each of the channel coding unit and the modulation unit may be independently controllable or may be configured to work in conjunction with one another. In another embodiment, the multiplexer unit 710 may multiplex multiple streams of data coming from the channel coding unit with different coding schemes and pass them as a single stream of data to the modulation unit.

Returning to FIG. 7A, in one embodiment, sets of representation data 422 are generated by the processor unit 610 using scalable precoding schemes. The sets of representation data 422 may then include a base layer and one or more enhancement layers. The layers may be multiplexed in the multiplexer unit 710 before being passed to the ACM unit 720. The ACM unit 720 may then use DVB-S2 to apply a QPSK 1/2 coding and modulation scheme to the multiplexed data, thereby generating a QPSK 1/2 signal for transmission over the communication link 260.

In some embodiments, the ACM unit 720 is further communicatively coupled to a profiler unit 730. The profiler unit 730 may be communicatively coupled with the communication link 260 and the precoder unit 230. The profiler unit 730 may also be configured to determine certain communication link profiles relating to the communication link 260. It will be appreciated that the profiler unit 730 may generate communication link profiles by detecting or receiving data intrinsic to and/or extrinsic to the communication link 260, by receiving information from other systems or components, or in any other useful way.

In one embodiment, the profiler unit 730 periodically or continuously determines signal-to-noise ratios (SNRs) relating to the communication link 260 for use as communication link profiles. For example, the profiler unit 730 may sample signals received at one end of the communication link 260 to determine the SNRs of the signals. Further, the SNRs may be recorded for statistical processing (e.g., to determine average SNRs or to determine SNR by signal type), for logging (e.g., to keep a record of SNRs at different times of day or in different link conditions), or for other reasons. It will be appreciated that the SNRs may be detected at either end of the communication link 260 (e.g., at either the gateway end or the subscriber terminal end) and by any effective method.

In another embodiment, the profiler unit 730 determines the bandwidth of the communication link 260 to generate a communication link profile. Similarly, the bandwidth of the communication link 260 may be provided to the profiler unit 730 manually or by another component, either before or when the communication link profile is generated. It will be appreciated that many other useful characteristics may be detected from the communication link 260 to generate communication link profiles, including, for example, throughput, hop count, path length, physical latency, bit error rate, power consumption, power availability, excess bandwidth, traffic congestion, etc.

In yet another embodiment, the profiler unit 730 determines an audience metric, which may be used as a communication link profile. There may be many ways to determine an audience metric. For example, the audience metric may be determined by detecting the number of subscribers receiving a signal, the number of subscribers playing back the signal (e.g., watching the video data), polling subscribers to determine the number of subscribers planning to playback the signal. In some embodiments, the signal may include multicast information (information transmitted to subscribers who have joined the multicast stream). In those embodiments, the audience metric may relate to the number or type of subscribers who have joined the multicast stream.

In still another embodiment, the profiler unit 730 may determine or receive a receiver capability, which may be used as a communication link profile. In some embodiments, a subscriber terminal 130 may include a receiver for receiving signals from the communication link 260. The receiver may have limited capabilities, due to limitations, for example, in a port or antenna, in a playback mechanism, in a decoding mechanism, etc. For example, a subscriber may be receiving video signals on a mobile phone. The phone may have a small screen with limited resolution, a small antenna with limited range, a small battery with limited power, etc.

In even another embodiment, the profiler unit 730 may determine or receive authorization to transmit signals over the communication link 260 in certain ways, which may be used as a communication link profile. In some embodiments, subscribers may have accounts with a service provider, which are associated with certain entitlement information. For example, a subscriber may be able to purchase a base package, which entitles the subscriber to receive and/or playback only base layer information generated by a scalable precoding scheme (e.g., a low-resolution video). Other subscribers may be able to purchase the additional entitlement to receive and/or playback enhanced layers (e.g., a high-definition video). In other embodiments, other parties may be at least partially responsible for the generation of the communication link profiles. For example, a backbone provider may allocate certain bandwidths to certain applications at certain times of the day.

In some embodiments, the profiler unit 730 is communicatively coupled with either or both of the ACM unit 720 and the precoder unit 230. Thus, in certain embodiments, the profiler unit 730 may use communication link profiles to determine certain parameters of precoding schemes used by the precoder unit 230 (e.g., scaling parameters, data partitions, etc.), or to assign identifiers to appropriate coding and modulation schemes. In other embodiments, the profiler unit 730 may generate, modify, or otherwise influence the functionality of both the ACM unit 720 and the precoder unit 230 in other ways to best suit data to various communication link profiles.

In an embodiment where the profiler unit 730 generates communication link profiles using an audience metric, different audience metrics may be used in different ways. For example, the bandwidth required for a popular program may be permitted to increase at the expense of less popular programs. To this effect, the popular program may be encoded at a high bit rate, and sent using a very low order (reliable) modulation and coding scheme. Alternately, the least popular programs may be encoded at a low bit rate, and sent using a high order modulation and coding scheme. In a satellite communication system according to this embodiment, one result may include an improved balance between the overall fixed bandwidth of the satellite transponder and service quality and availability.

In another embodiment, the profiler unit 730 generates communication link profiles at least in part based on weather patterns. As the weather worsens, link conditions may also worsen, decreasing the reliability of data transfers over the communication link 260. To compensate for worsening conditions, the profiler unit 730 may direct the ACM unit 720 to increase transmission reliability by using higher order coding and modulation schemes (e.g., higher order modulation schemes, lower information density, etc.). The change in coding and modulation schemes may be implemented, for example, by assigning identifiers to higher order coding and modulation schemes in a table like the identifier data table 522 of FIG. 5. The new assignments in the table may then be used by the ACM unit 720 to generate the set of output data 620 for transmission.

In yet another embodiment, the profiler unit 730 generates communication link profiles at least in part based on notifications generated by a subscriber terminal 130. As discussed above with reference to FIG. 3, embodiments of subscriber terminals 130 may be configured to provide notices on certain conditions. For example, a subscriber terminal 130 may be configured to store received and decoded sets of representation data 422 for later playback by a subscriber. The subscriber terminal 130 may provide notifications, for example, when certain sets of representation data 422 failed to be reliably received (e.g., and must be resent), when subscribers request or subscribe to certain sets of representation data 422, etc. In these and other cases, the profiler unit 730 may receive a notification and generate communication link profiles to respond to those notifications. For example, if a set of representation data 422 failed to be received, the set of representation data 422 may be retransmitted using a more reliable coding and modulation scheme.

In still another embodiment, the profiler unit 730 may generate communication link profiles based on a variety of different types of data. For example, the profiler unit 730 may receive a notification from a subscriber terminal 130 requesting retransmission of a set of representation data 422. The profiler unit 730 may poll the communication link 260 to determine its bandwidth, waiting to detect that excess bandwidth is available. When excess bandwidth is available on the communication link 260, the profiler unit 730 may direct the ACM unit 720 to retransmit the requested set of representation data 422 using a very reliable (but bandwidth inefficient) coding and modulation scheme.

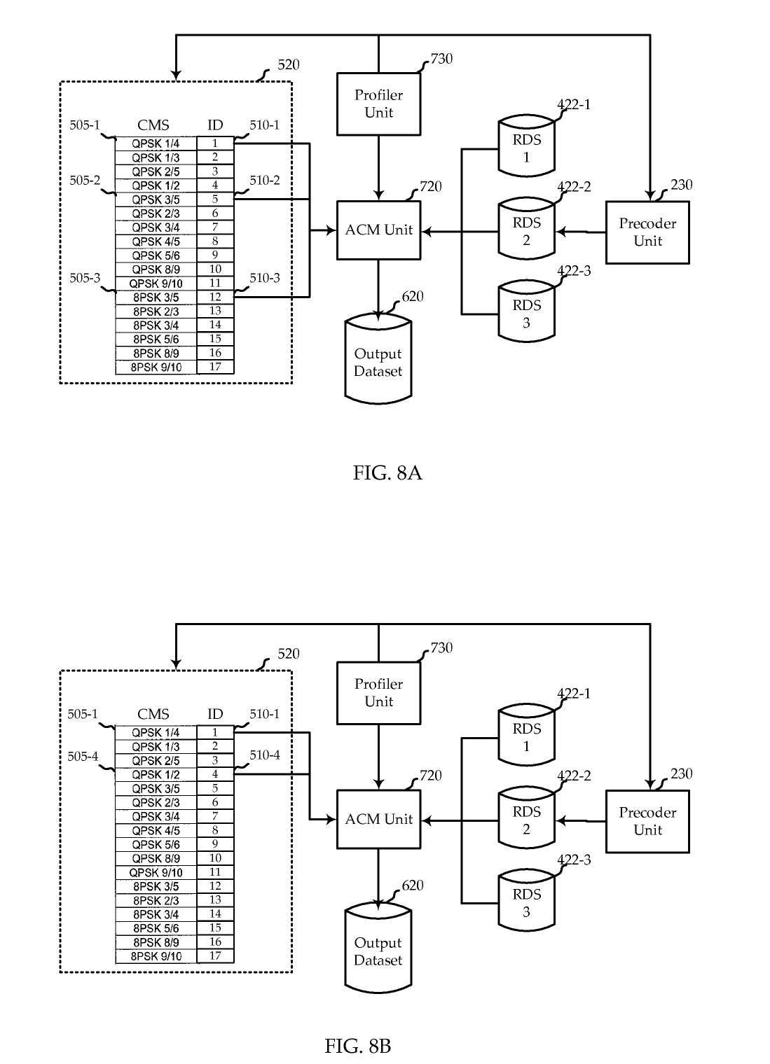

FIG. 8A and FIG. 8B provide an exemplary embodiment illustrating adapting coding and modulation schemes to link conditions according to various embodiments of the invention. In FIG. 8A, three sets of representation data (422-1, 422-2, and 422-3) pass from a precoder unit 230 to an ACM unit 720. Based on information provided by the profiler unit 730, identifiers 510 have been assigned to coding and modulation schemes 505 in an identifier data store 520.

As illustrated, the first set of representation data 422-1 is associated with identifier “1” 510-1, which is further identified with a QPSK 1/4 coding and modulation scheme 505-1. The second set of representation data 422-2 is associated with identifier “2” 510-2, which is further identified with a second coding and modulation scheme 505-2. The second coding and modulation scheme 505-2 represents the same order modulation scheme (i.e., QPSK) as the first coding and modulation scheme 505-1, but with higher information density (i.e., 3/5 provides fewer error correction bits per information bit than 1/4). The third set of representation data 422-3 is associated with identifier “3” 510-3, which is further identified with a third coding and modulation scheme 505-3. The third coding and modulation scheme 505-3 represents a higher order modulation scheme than the first coding and modulation scheme 505-1 (i.e., 8PSK instead of QPSK), but with the same information density (i.e., 3/5). Thus, the first set of representation data 422-1 may be transmitted with the highest reliability, relative to the other sets of representation data (422-2 and 422-3).

FIG. 8B illustrates the same embodiment of the invention, illustratively adapted to worsening link conditions. Still, three sets of representation data (422-1, 422-2, and 422-3) pass from a precoder unit 230 to an ACM unit 720. Here, however, the profiler unit 730 has detected worsening link conditions (e.g., heavy rain). In response, identifiers 510 have been reassigned to more reliable coding and modulation schemes 505 in the identifier data store 520.

As illustrated, the first set of representation data 422-1 is still associated with identifier “1” 510-1, which is still further identified with a QPSK 1/4 coding and modulation scheme 505-1. No change is made to these assignments, as the QPSK 1/4 coding and modulation scheme is the most reliable option provided in the identifier data store 520. However, the second set of representation data 422-2 associated with identifier “2” 510-2 is now further associated with a new coding and modulation scheme 505-4 (QPSK 1/2). The new coding and modulation scheme 505-4 represents the same order modulation scheme (i.e., QPSK) as the second coding and modulation scheme 505-2 used in FIG. 8A, but with lower information density (i.e., 1/2 instead of 3/5). Further, the third set of representation data 422-3 is re-associated with identifier “2” 510-2, further associating the third set of representation data 422-3 with the same new coding and modulation scheme 505-4 as is associated with the second set of representation data 422-2. Now, the first set of representation data 422-1 may still be transmitted with the highest reliability, but the other sets of representation data (422-2 and 422-3) will also be more reliably transmitted.

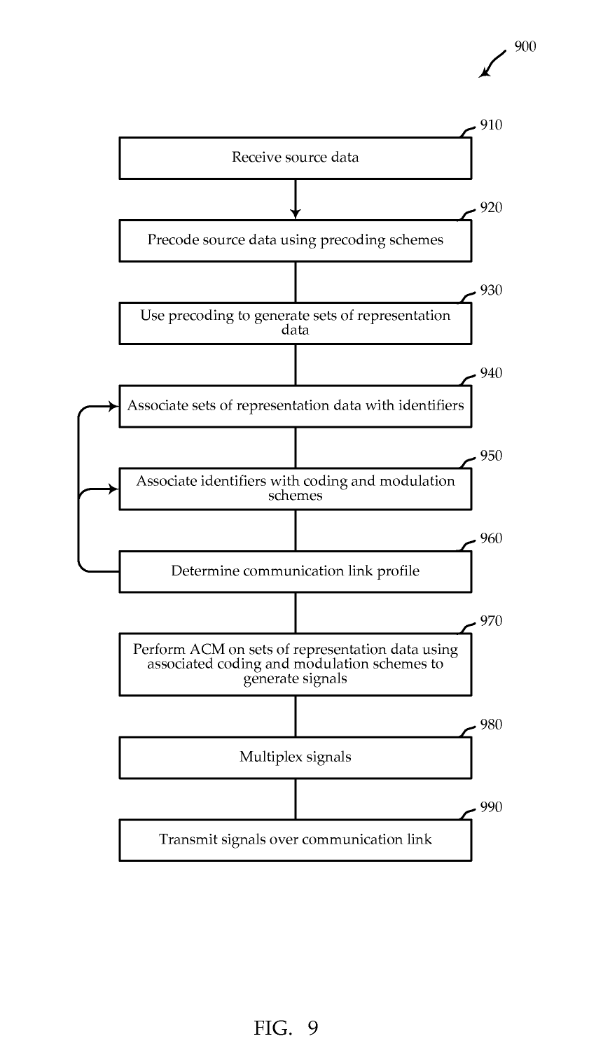

The features of the various embodiments of FIGS. 1-8 may be implemented in a number of ways according to the invention. Further, the components and functionalities in those figures may be used to perform a number of different methods according to the invention. FIG. 9 provides a flow diagram describing methods of transmitting hierarchical data in a layered communication system according to various embodiments of the invention.

The method 900 may begin by receiving a set of source data at block 910. The set of source data may be any type of data, for example audio-visual data. The set of source data may be precoded at block 920, using various precoding schemes. The precoding at block 920 may generate sets of representation data at block 930.

At block 940, the sets of representation data generated at block 930 may be associated with identifiers. In some embodiments, each identifier is associated with a coding and modulation scheme at block 950. As such, each set of representation data may be associated to a coding and modulation scheme.

In some embodiments, a communication link profile is determined at block 960. The communication link profile may relate to link conditions, receiver capabilities, subscriber entitlement, audience metrics, or any other useful characteristic of the communication environment in which the method 900 is being implemented. In certain embodiments, assignments in either or both of blocks 940 and 950 may be dynamically adjusted to adapt to information from the communication link profile determined at block 960.

At block 970, ACM is performed on the sets of representation data using their associated coding and modulation schemes to generate one or more signals. In some embodiments, the signals may be multiplexed at block 980 to generate a single signal for transmission. The signal or signals may then be transmitted over a communication link at block 990.

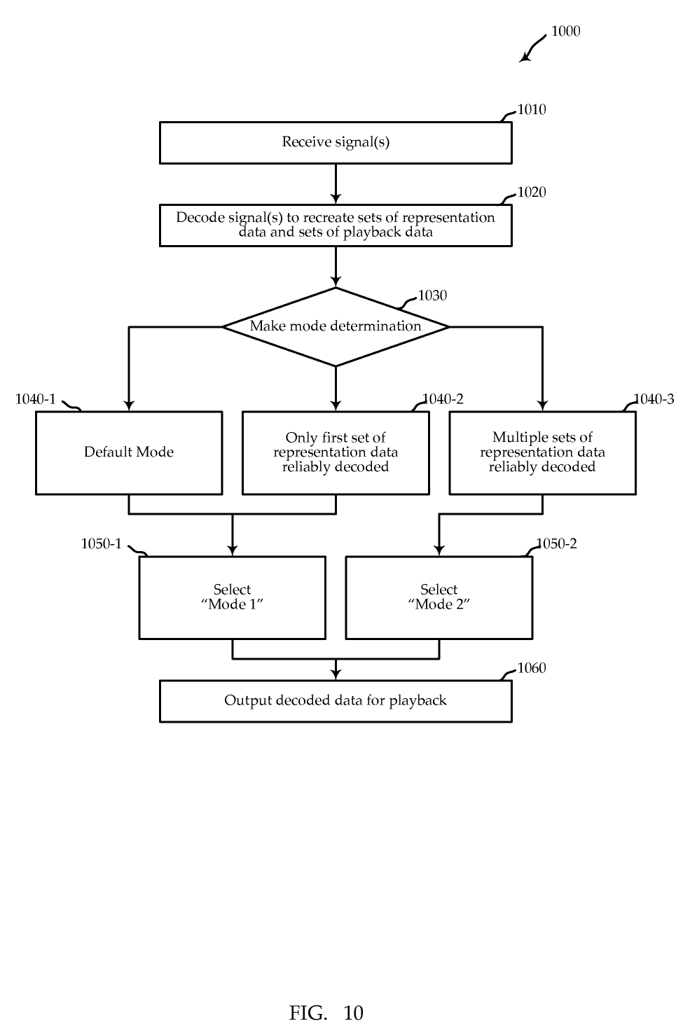

FIG. 10 provides a flow diagram describing methods of receiving hierarchical data in a layered communication system according to various embodiments of the invention. The method 1000 may begin by receiving one or more signals at block 1010. The signals may contain coded and/or modulated sets of representation data from a set of source data. At block 1020, the signals may be decoded to recreate the sets of representation data, and to use the sets of representation data to playback a representation of the set of source data.

In some embodiments, multiple modes may be available for decoding the signals. At block 1030, a mode determination may be made. This mode determination may be based on any useful parameter, like signal quality of the received signals. In a first embodiment, a default mode is used at block 1040-1, resulting in a selection of “Mode 1” at block 1050-1. In a second embodiment, at block 1040-2, the received signal contains only a first set of representation data, or other sets of representation data cannot be reliably decoded (e.g., they are received with high bit error rates). In this second embodiment, “Mode 1” is also selected at block 1050-1. In a third embodiment, multiple sets of representation data are received at block 1040-3, allowing decoding for a high level playback of the set of source data. In this third embodiment, a second mode, “Mode 2,” is selected at block 1050-2. At block 1060, the data decoded in the various modes at blocks 1040 may be output for playback.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for hierarchical representation of a set of source data in a satellite environment using adaptive coding and modulation, the system comprising:
a gateway comprising:
a receiver unit configured to receive a set of source data;
a precoder unit, communicatively coupled with the receiver unit, and configured to:
precode at least a subset of the set of source data using a first precoding scheme to generate a first set of representation data, decodable independently to provide a set of first-level playback data representing the set of source data; and
precode at least a subset of the set of source data using a second precoding scheme to generate a second set of representation data, decodable in combination with the first set of representation data to provide a set of second-level playback data representing the set of source data;
an adaptive coding and modulation unit, communicatively coupled with the precoder unit, and configured to associate the first set of representation data with a first coding and modulation scheme and to associate the second set of representation data with a second coding and modulation scheme, wherein the second coding and modulation scheme is of a higher order than the first coding and modulation scheme; and
a transceiver unit, communicatively coupled with the adaptive coding and modulation unit, and configured to transmit a signal over a communication link, the signal relating to applying the first coding and modulation scheme to the first set of representation data and applying the second coding and modulation scheme to the second set of representation data; and
a subscriber terminal, configured to:
receive the signal from the communication link;
decode, in a first mode, the first set of representation data from the signal to generate the set of first-level playback data representing the set of source data; and
decode, in a second mode, a combination of the first set of representation data and the second set of representation data from the signal to generate the set of second-level playback data representing the set of source data.

2. The system of claim 1, wherein the gateway further comprises:
a profiler unit, communicatively coupled with the adaptive coding and modulation unit, and configured to determine a profile relating at least in part to a set of conditions for the communication link,
wherein the adaptive coding and modulation unit is further configured, based at least in part on the profile, to associate the first set of representation data with the first coding and modulation scheme and associate the second set of representation data with the second coding and modulation scheme.

3. The system of claim 1, wherein:
the source data comprises audio-visual data; and
the set of first-level playback data is of a lower resolution than the set of second level playback data.

4. A device for hierarchical communication of a set of source data over a communication link, the device comprising:
a representation data store, configured to store sets of representation data comprising:
a first set of representation data generated by a first precoding scheme, and formatted to be decoded independently to provide a set of first-level playback data representing the set of source data; and
a second set of representation data generated by a second precoding scheme, and formatted to be decoded to provide a set of second-level playback data representing the set of source data when combined with the first set of representation data, wherein the second precoding scheme is different from the first precoding scheme;
an identifier data store, configured to store a set of identifiers, each identifier representing one of a set of coding and modulation schemes for data transmission over the communication link; and
a processor unit, communicatively coupled with the representation data store and the identifier data store, and configured to:
associate at least one of the sets of representation data with at least a first coding and modulation scheme from the set of coding and modulation schemes represented by a first identifier; and
associate at least another of the sets of representation data with at least a second coding and modulation scheme from the set of coding and modulation schemes represented by a second identifier, the second coding and modulation scheme being of a higher order than the first coding and modulation scheme.

5. The device of claim 4, further comprising:
a transmitter unit, communicatively coupled with the processor unit, and configured to transmit a signal over a communication link, the signal relating at least to applying the first coding and modulation scheme to the first set of representation data.

6. The device of claim 4, further comprising:
a precoder unit, communicatively coupled with the processor unit, and configured to precode at least a portion of the set of source data using at least one precoding scheme to generate at least one of the sets of representation data,
wherein the processor unit is further configured to control at least a portion of a set of precoding parameters used by the precoder unit to precode the set of source data into the at least one of the sets of representation data using the at least one precoding scheme.

7. The device of claim 4, further comprising:
a profiler unit, communicatively coupled with the processor unit, and configured to determine a profile relating at least in part to a set of conditions for at least one of the communication link, a gateway, or a plurality of subscriber terminals,
wherein the processor unit is further configured to associate one or more of the sets of representation data with the set of identifiers based at least in part on the profile.

8. The device of claim 4, further comprising:
a profiler unit, communicatively coupled with the processor unit, and configured to determine a profile relating at least in part to the signal-to-noise ratio of signals received by at least one of a gateway side of the communication link or a subscriber terminal side of the communication link,
wherein the processor unit is further configured to associate one or more of the sets of representation data with the set of identifiers based at least in part on the profile.

9. The device of claim 4, further comprising:
a profiler unit, communicatively coupled with the processor unit, and configured to:
receive an audience metric relating to at least one characteristic of an audience of the set of source data; and
determine a profile relating at least in part to the audience metric,
wherein the processor unit is further configured to associate one or more of the sets of representation data with the set of identifiers based at least in part on the profile.

10. The device of claim 4, further comprising:
a profiler unit, communicatively coupled with the processor unit, and configured to determine a profile relating at least in part to the bandwidth of the communication link,
wherein the processor unit is further configured to associate one or more of the sets of representation data with the set of identifiers based at least in part on the profile.

11. The device of claim 4, further comprising:
a profiler unit, communicatively coupled with the processor unit, and configured to determine a profile relating at least in part to the signal-to-noise ratio of signals received by a plurality of subscriber terminals, the plurality of subscriber terminals being configured to receive data over the communication link; and
the processor unit is further configured to associate one or more of the sets of representation data with the set of identifiers based at least in part on the profile.

12. The device of claim 4, further comprising:
a profiler unit, communicatively coupled with the processor unit, and configured to determine a profile relating at least in part to a set of conditions for at least a portion of a plurality of subscriber terminals,
wherein at least one of the subscriber terminals comprises a receiver, the receiver having a receiving capability, and
wherein the processor unit is further configured to associate one or more of the sets of representation data with the set of identifiers based at least in part on the receiving capability of the receiver.

13. The device of claim 4, further comprising:
a profiler unit, communicatively coupled with the processor unit, and configured to determine a profile relating at least in part to a set of conditions for a subscriber terminal,
wherein the subscriber terminal is associated with a subscriber account, the subscriber account comprising entitlement information, and
wherein the processor unit is further configured to associate one or more of the sets of representation data with the set of identifiers based at least in part on the entitlement information.

14. The device of claim 4, further comprising:
a profiler unit, communicatively coupled with the processor unit, and configured to determine a profile relating at least in part to a set of conditions for a communication link,
wherein the communication link carries data comprising a multicast data stream subscribed to by a subset of subscriber terminals, and
wherein the processor unit is further configured to associate one or more of the sets of representation data with the set of identifiers based at least in part on characteristics of the subset of subscriber terminals that have subscribed to the multicast.

15. The device of claim 4, wherein:
the unique coding and modulation scheme defined by the first identifier has a same coding scheme as the unique coding and modulation scheme defined by the second identifier; and
the unique coding and modulation scheme defined by the first identifier has a different modulation scheme from the unique coding and modulation scheme defined by the second identifier.

16. The device of claim 4, further comprising:
a multiplexer unit configured to multiplex at least a portion of the first set of representation data and the second set of representation data to generate an output dataset.

17. The device of claim 4, wherein the first precoding scheme comprises a at least one of a scalable precoding scheme or a data partitioning scheme.

18. A method for hierarchical communication of a set of source data over a communication link, the method comprising:
receiving a first set of representation data generated by a first precoding scheme, wherein at least a subset of the first set of representation data is formatted to be decoded independently to provide a set of first-level playback data representing the set of source data;
receiving a second set of representation data generated by a second precoding scheme, wherein at least a subset of the second set of representation data is formatted to be decoded to provide a set of second-level playback data representing the set of source data when combined with the first set of representation data, and wherein the second coding scheme is different from the first coding scheme;
associating a first coding and modulation scheme with the first set of representation data

19. The method of claim 18, further comprising:
associating a second coding and modulation scheme with the second set of representation data, the second coding and modulation scheme being of a higher order than the first coding and modulation scheme.

20. The method of claim 18, further comprising:
precoding at least a portion of the set of source data into the first set of representation data using the first precoding scheme.

21. The method of claim 18, further comprising:
determining a profile relating to conditions of at least one of the communication link, a gateway, or a subscriber terminal,
wherein at least one of the associating steps is based at least in part on the profile.

22. A method for receiving hierarchical communication of a set of source data over a communication link, the method comprising:
receiving, from the communication link, at least a portion of a first signal generated by applying a first precoding scheme and a first coding and modulation scheme to the set of source data, and comprising a first set of representation data formatted to be decoded independently to provide a set of first-level playback data representing the set of source data;
receiving, from the communication link, at least a portion of a second signal generated by applying a second precoding scheme and a second coding and modulation scheme to the set of source data, and comprising a second set of representation data formatted to be decoded to provide a set of second-level playback data representing the set of source data when combined with the first set of representation data;
decoding, in a first mode, the first set of representation data to generate the set of first-level playback data representing the set of source data; and
decoding, in a second mode, a combination of the first set of representation data and the second set of representation data to generate the set of second-level playback data representing the set of source data.

23. The method of claim 22, further comprising:
detecting a signal quality level relating to a signal quality of the portion of the second signal received from the communication link;
automatically entering the second mode when the signal quality level exceeds a threshold; and
automatically entering the first mode when the signal quality level does not exceed the threshold.

24. The method of claim 23, wherein detecting the signal quality level comprises detecting at least one of a signal-to-noise ratio or a bit error rate of the portion of the second signal received from the communication link.

25. The method of claim 22, further comprising:
storing at least a portion of the first set of representation data in relation to a source data pointer; and
storing at least a portion of the second set of representation data in relation to the source data pointer.

26. A device for hierarchical communication of a set of source data over a communication link, the device comprising:
a means for storing sets of representation data comprising:
a first set of representation data generated by a first precoding scheme, and formatted to be decoded independently to provide a set of first-level playback data representing the set of source data;
a second set of representation data generated by a second precoding scheme, and formatted to be decoded to provide a set of second-level playback data representing the set of source data when combined with the first set of representation data;
a means for storing a set of identifiers, each identifier representing one of a set of coding and modulation schemes for data transmission over the communication link, the set of coding and modulation schemes comprising:
a first coding and modulation scheme is represented by a first identifier; and
a second coding and modulation scheme represented by a second identifier, the second coding and modulation scheme being of a higher order than the first coding and modulation scheme; and
a means for associating each of at least a subset of the sets of representation data with at least one of the set of identifiers.
